(19) United States
(12) Patent Application Publication
(10) Pub. No.: US 2007/0087235 A1
(43) Pub. Date: Apr. 19, 2007

(54) Multi-layered thin film hydrogen fuel cell system

(75) Inventors: Sung Han Kim, Suwon (KR); Sang Jin Kim, Suwon (KR); Ro Woon Lee, Seoul (KR); Jae Hyoung Gil, Seoul (KR); Jae Hyuk Jang, Sungnam (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/524,195

(22) Filed: Sep. 21, 2006

(30) Foreign Application Priority Data
Oct. 17, 2005 (KR) 10-2005-0097594

(51) Int. Cl. H01M 8/06; H01M 8/04; H01M 8/10; H01M 2/08

(52) U.S. Cl. 429/19; 429/20; 429/26; 429/33; 429/35

(57) ABSTRACT

The invention relates to a micro multi-layered thin film hydrogen fuel cell system, which includes a reformer comprising a flow path formed at a side of a substrate and a catalyst in the flow path to reform a fuel into hydrogen. The fuel cell system also includes a cell for generating current using the hydrogen from the reformer. The cell comprises a pair of first and second substrates covering the substrate of the reformer with a membrane electrode assembly disposed between the pair of substrates with a catalyst formed thereon. The fuel cell system further includes a combustor for burning remaining fuel gas to generate heat. The combustor comprises a substrate disposed at an outer side of the second substrate of the cell, and a flow path formed in the substrate with a catalyst formed thereon.

### CLAIM OF PRIORITY

This application claims the benefit of Korean Patent Application No. 2005-97594 filed on Oct. 17, 2005, in the Korean Intellectual Property Office, the disclosure of which is incorporated herein by reference.

### BACKGROUND OF THE INVENTION

1. Field of the Invention

The present invention relates to a micro multi-layered thin film hydrogen fuel cell system, and more particularly, to a multi-layered thin film hydrogen fuel cell system which has a multi-layered thin film structure integrally combined with a hydrogen-generation reformer using Micro-Electro-Mechanical Systems (MEMS), thus using hydrocarbon compound fuel and easily mass-produced, thereby producing high-capacity, high-efficiency electricity.

2. Description of the Related Art

In general, fuel cells are classified into various types including polymer electrolyte membrane fuel cells, direct methanol fuel cells, molten carbonate fuel cells, solid oxide fuel cells, phosphoric acid fuel cells, and alkaline fuel cells. Of these types, the most extensively used ones are the direct methanol fuel cell (DMFC) and polymer electrolyte membrane fuel cell (PEMFC). The DMFC and PEMFC use the same constituents and material but differ in that they use methanol and hydrogen, respectively, thus having different but comparable capacities and fuel supply systems.

Recently, the researches on the DMFC have been actively under way because of its increased application value for a power source for portable devices. This is due to the fact that although having low output density, the DMFC has a simple fuel supply system to enable miniaturization of the overall structure.

A gaseous fuel cell has an advantage in that it has great energy density but requires caution in handling the hydrogen gas and additional equipment such as a fuel reforming apparatus for processing methane or alcohol to produce hydrogen gas or the fuel gas, thus resulting in a large volume.

On the contrary, although having low energy density, a liquid fuel cell using liquid as fuel is relatively manageable in terms of handling the fuel therefor and has a low driving temperature. In particular, it does not require a reformer, thus known to be suitable as a small, general-purpose portable power source.

Due to such advantages of the liquid fuel cells, many researches have been conducted on the DMFC, the most representative liquid fuel cell, to improve practical feasibility of the liquid fuel cells.

The DMFC generates power based on electromotive force generated from the reaction at a fuel electrode side in which methanol is oxidized and the reaction at an air electrode side in which oxygen is reduced. At this time, the reactions occurring at the fuel electrode side and the air electrode side are as follows.

Fuel electrode (anode): CH₃OH+H₂O→CO₂+6H⁺+6e⁻

Air electrode (cathode): 3/2O₂+6H⁺+6e⁻→3H₂O

Net: CH₃OH+H₂O+ 3/2O₂→CO₂+3H₂O

Based on the above reaction equations, conventional researches have been mainly focused on the application of the fuel cells for the mobile and portable power sources. FIG. 1 illustrates a conventional unit fuel cell 300 in which an electrolyte layer 310 of a general solid polymer electrolyte membrane is disposed in the center with an anode 312a and a cathode 312b disposed at outer sides thereof. A methanol supply mechanism 330 and an oxygen supply mechanism 340 are installed at outer sides of the anode 312a and the cathode 312b, respectively.

The methanol supply mechanism 330 includes a methanol storage tank 332 and methanol and water supply pumps 334, and the oxygen supply mechanism 340 includes an oxygen compressor 342. As a result, the hydrogen fuel cell 300 has a large volume overall.

FIG. 2 illustrates another conventional technology, a PEMFC system 400 using hydrogen unlike the DMFC using methanol.

Such a PEMFC system 400 includes an electrolyte membrane 410 having an anode 412a and a cathode 412b, a hydrogen supply system 420 for supplying hydrogen to the anode 412a and the cathode 412b, and an air supply system 430 for supplying air.

The PEMFC system 400 generates electricity through the reactions below.

Anode: H₂->2H₊+2e₋

Cathode: (½)O₂+2H₊+2e₋-->H₂O

Net: H₂+(½)O₂-->H₂O

The PEMFC system 400 using hydrogen is divided into a type in which hydrogen is directly supplied from a hydrogen storage tank (not shown) and a type in which liquid fuel such as methanol is reformed to extract hydrogen.

The first type requires supply of hydrogen from a hydrogen storage container. With the current technology with low efficiency in hydrogen storage, however, miniaturization of the entire system to the degree usable in a mobile phone does not seem feasible.

As for the second type, which involves using the reformer to supply hydrogen, it is difficult to manufacture the reformer first of all. Moreover, the reforming reaction typically requires high temperature of about 200° C. to 300° C., incurring high power consumption. Also, and the generally used electrolyte membrane such as nafion cannot withstand such high temperature.

Therefore, it has been considered in the art that it is impossible to mount the reformed hydrogen fuel cell (RHFC), which includes a reformer mounted thereon, to a small information apparatus such as a mobile phone. Thus there has been a need for developing a micro fuel cell for such use.

FIG. 3 illustrates a conventional micro fuel cell 500 disclosed in U.S. Pat. No. 6,569,553. The fuel cell 500 includes a reaction zone 510 in which pure methanol is reformed into hydrogen, and a cell stack 520 having a plurality of electrolyte membranes disposed downstream of the reformer 510 with catalyst formed thereon to generate current using the hydrogen from the reformer 510. The fuel cell 500 also includes a waste heat recovery zone 530 for collecting waste gas passed through the cell stack 520 to recover and discharge waste heat through an exhaust gas vent 530 to the outside.

That is, the micro fuel cell 500 has the plurality of cell stacks 520 disposed downstream of the reaction zone 510 and the waste heat recovery zone 530 disposed downstream of the cell stacks 520, realizing an integrated fuel cell. However, the fuel cell 500 is not suitable for miniaturization since it fails to realize an efficient structure such as a stacked structure of thin films.

### SUMMARY OF THE INVENTION

The present invention has been made to solve the foregoing problems of the prior art and therefore an object of certain embodiments of the present invention is to provide a multi-layered thin film hydrogen fuel cell system which is applicable as a power supplying device like a battery or a portable electric generator for a portable electronic device such as a mobile phone, a personal digital assistant, a camcorder, a digital camera, a notebook computer and the like.

Another object of certain embodiments of the invention is to provide a multi-layered thin film hydrogen fuel cell system which has a multi-layered thin film structure integrally combined with a hydrogen-generating reformer using MEMS, using hydrocarbon compound fuel such as methanol, dimethyl, ethylene, or dimethyl-ether (DME) and easily mass-produced, thereby producing high-capacity, high-efficiency electricity.

According to an aspect of the invention for realizing the object, there is provided a multi-layered thin film hydrogen fuel cell system using hydrogen carbon compound as fuel, including: a reformer comprising a flow path formed at a side of a substrate and a catalyst in the flow path to reform a fuel into hydrogen; a cell for generating current using the hydrogen from the reformer, the cell comprising a pair of first and second substrates covering the substrate of the reformer, the first substrate disposed at the side of the reformer, and a Membrane Electrode Assembly (MEA) disposed between the pair of substrates with a catalyst formed thereon; and a combustor for burning remaining fuel gas to generate heat, the combustor comprising a substrate disposed at an outer side of the second substrate of the cell and a flow path formed in the substrate with a catalyst formed thereon.

According to another aspect of the invention for realizing the object, there is provided a multi-layered thin film hydrogen fuel cell system using hydrocarbon compound as fuel, including: a reformer comprising a flow path formed at a side of a substrate and a catalyst formed in the flow path to reform a fuel into hydrogen; first and second cells disposed at both sides of the reformer for utilizing hydrogen from the reformer to generate current, each of the cells comprising a substrate to cover the substrate of the reformer and a Membrane Electrolyte Assembly (MEA) disposed in the substrate of the cell with a catalyst thereon; and first and second combustors for burning remaining fuel gas, the first combustor disposed at an outer side of the substrate of the first cell, the second combustor disposed at an outer side of the substrate of the second cell, each of the combustors comprising a substrate having a flow path formed in the substrate of the combustor with a catalyst formed thereon.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a conventional DMFC fuel cell;

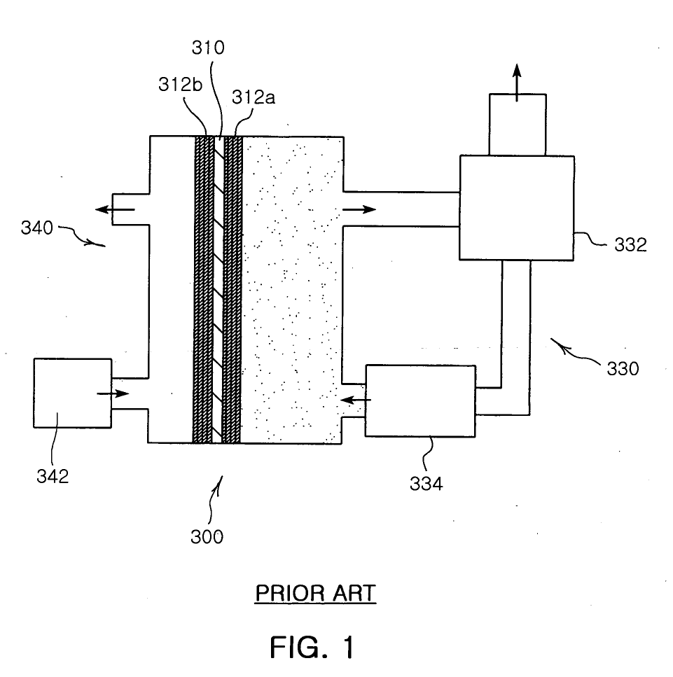

FIG. 2 is a sectional view illustrating a conventional PEMFC fuel cell;

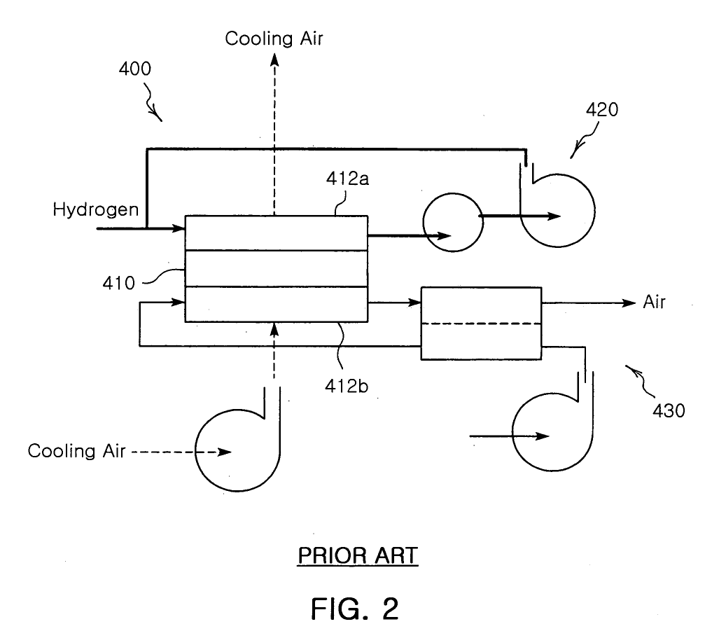

FIG. 3 is an exploded view illustrating another type of conventional fuel cell;

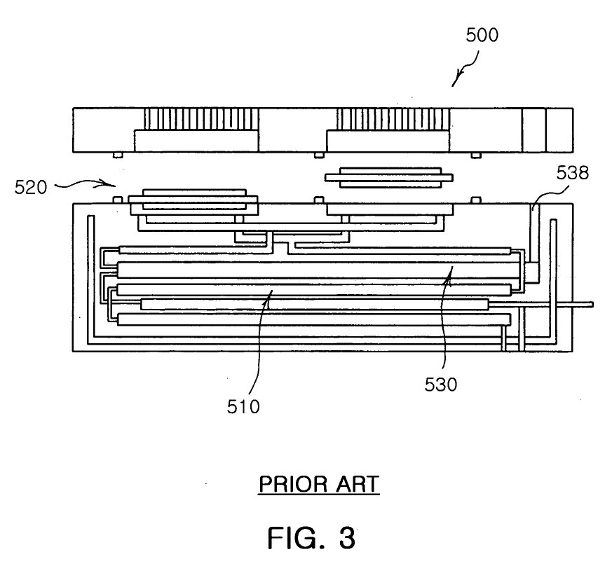

FIG. 4 is an exploded side sectional view illustrating a multi-layered hydrogen fuel cell system according to a first embodiment of the present invention;

FIG. 5 is a block diagram illustrating the basic concept of the multi-layered thin film hydrogen fuel cell system according to the first embodiment of the present invention;

FIG. 6 is an assembled sectional view illustrating the multi-layered thin film hydrogen fuel cell system according to the first embodiment of the present invention;

FIG. 7 is a perspective view illustrating a reformer provided in the multi-layered thin film hydrogen fuel cell system according to the first embodiment of the present invention;

FIG. 8a is a perspective view illustrating a second substrate of a cell of the multi-layered hydrogen fuel cell system according to the first embodiment of the present invention;

FIG. 8b is a perspective view illustrating a second current collector of the cell of the multi-layered thin film hydrogen fuel cell system according to the first embodiment of the present invention;

FIG. 9a is a perspective view illustrating a first substrate of the cell of the multi-layered thin film hydrogen fuel cell system according to the first embodiment of the present invention;

FIG. 9b is a perspective view illustrating a first current collector of the cell of the multi-layered thin film hydrogen fuel cell system according to the first embodiment of the present invention;

FIG. 10 is a detailed exploded perspective view illustrating a Membrane Electrolyte Assembly (MEA) and gaskets provided in the cell of the multi-layered hydrogen fuel cell system according to the first embodiment of the present invention;

FIG. 11 is a perspective view illustrating a combustor of the multi-layered thin film hydrogen fuel cell system according to the first embodiment of the present invention;

FIG. 12 is an exploded side sectional view of a multi-layered thin film hydrogen fuel cell system according to a second embodiment of the present invention;

FIG. 13 is an exploded perspective view illustrating a principal part of the multi-layered thin film hydrogen fuel cell system according to the second embodiment of the present invention;

FIG. 14 is an assembled side sectional view illustrating the multi-layered thin film hydrogen fuel cell system according to the second embodiment of the present invention;

FIG. 15 is a perspective view illustrating a first substrate of a cell of the multi-layered thin film hydrogen fuel cell system according to the second embodiment;

FIG. 16 is a perspective view illustrating a second substrate of the cell of the multi-layered thin film hydrogen fuel cell system according to the second embodiment of the present invention;

FIG. 17 is an exploded view illustrating a second cell provided in the multi-layered thin film hydrogen fuel cell system according to the second embodiment of the present invention;

FIG. 18a is a perspective view illustrating a first current collector of the second cell of the multi-layered thin film hydrogen fuel cell system according to the second embodiment of the present invention;

FIG. 18b is a perspective view illustrating a second current collector of the second cell of the multi-layered thin film hydrogen fuel cell system according to the second embodiment of the present invention;

FIG. 19 is an exploded perspective view illustrating a second combustor and a glass cover of the multi-layered thin film hydrogen fuel cell system according to the second embodiment of the present invention; and

FIG. 20 is a perspective view illustrating an exterior of an insulation layer of the multi-layered thin film hydrogen fuel cell system according to the second embodiment of the present invention.

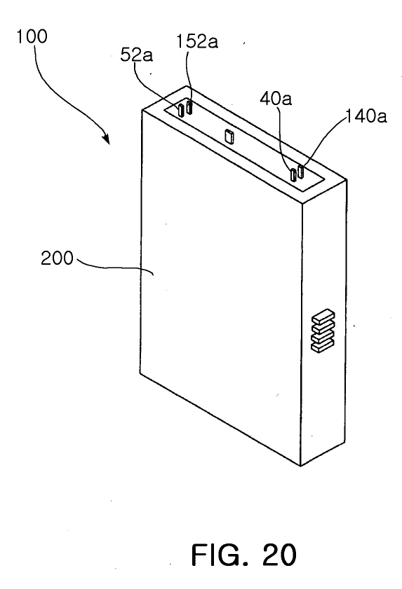

### DETAILED DESCRIPTION OF THE PREFERRED EMBODIMENT

Preferred embodiments of the present invention will now be described in detail with reference to the accompanying drawings.

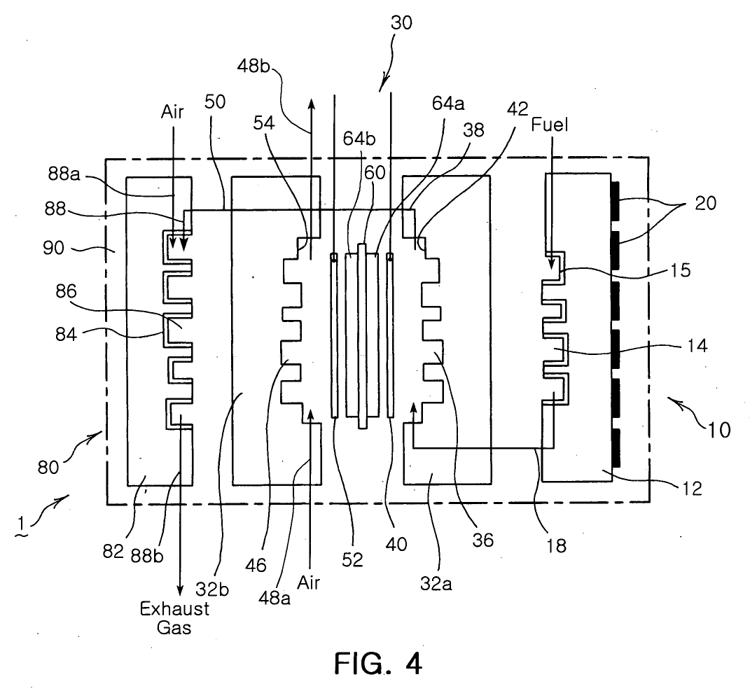

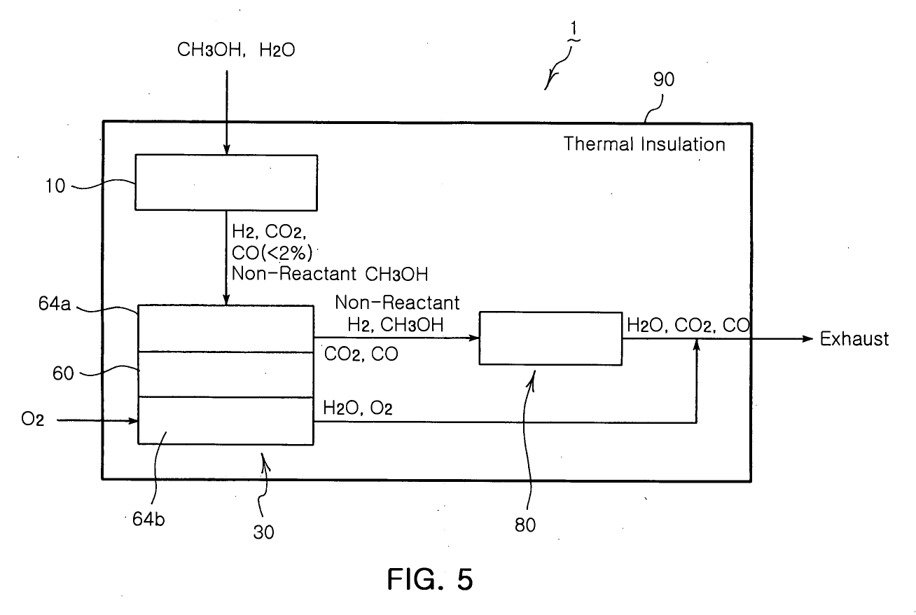

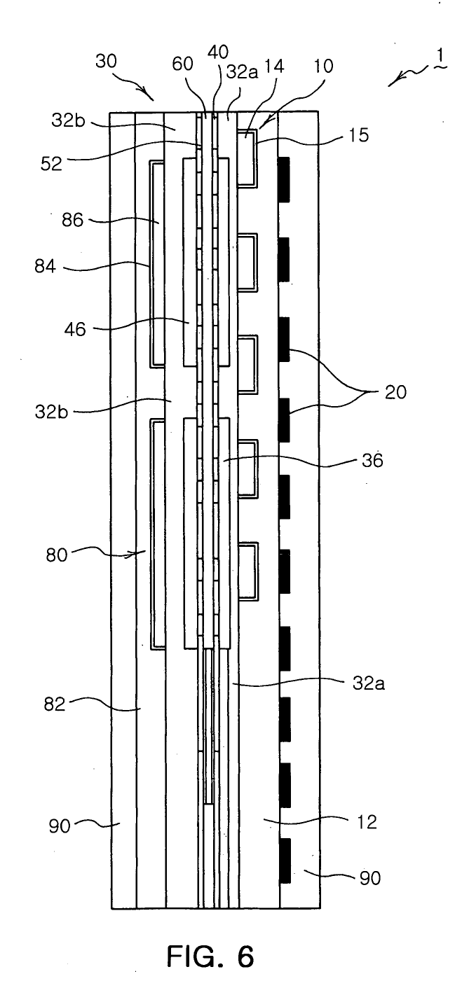

As shown in FIGS. 4 to 6, a multi-layered thin film hydrogen fuel cell system 1 has a reformer 10 having a flow path 14 formed in a side of a substrate 12, and a catalyst 15 formed in the flow path 14, thereby reforming fuel into hydrogen.

The reformer 10 is a part for generating hydrogen from the fuel, and generally adopts a catalyst made of CuO/ZnO/Al₂O₃ or Cu/ZnO/Al₂O₃ in the case of methanol steam reformation. The reforming reaction temperature of the reformer 10 is selected in the range of 150° C. to 250° C. considering hydrogen conversion rate and CO generation concentration of 2% or less so that a Membrane Electrode Assembly (hereinafter referred to as ‘MEA’) 60 is not affected.

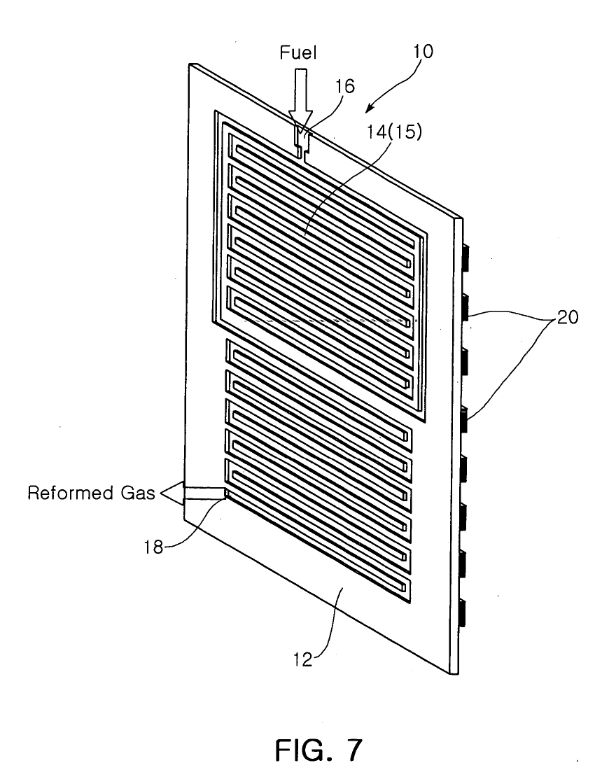

The substrate 12 of the reformer 10 is made of Si, and as shown in FIG. 7, has the flow path 14 recessed in zigzag in a side thereof. In addition, the flow path 14 has a fuel inlet 16 formed at one side thereof, and has a reformed gas outlet 18 for emitting reformed gas to a cell 30, explained later, formed at the other side thereof.

In addition, the flow path 14 of the reformer 10 has a width of about 1 mm and a depth of about 250 μm. The catalyst 15 composed of CuO/ZnO/Al₂O₃ or Cu/ZnO/Al₂O₃ is deposited on the inner wall of the flow path 14. The reformer 10 has a heater including a heating wire 20 made of electrically resistive wire on the rear side of the substrate 12 where the flow path 14 is formed.

Therefore, when hydrocarbon compound fuel, for example, methanol (CH₃OH) and water (H₂O) is supplied through the fuel inlet 16, and heated at a reaction temperature ranging from 150° C. to 250° C., a reforming process accompanying heat absorption reaction takes place, and thus hydrogen gas (H₂) and a small amount of, preferably, less than 2% of CO, water and CO₂, is emitted from the reformed gas outlet 18.

As described above, methanol (CH₃OH) and water (H₂O) supplied through the flow path 14 of the reformer 10 is first gasified by the high temperature, migrating downward from the fuel inlet 16 to the reformed gas outlet 18, and thereby reformed to generate hydrogen.

In addition, the fuel cell system 1 of the present invention includes a cell 30 for utilizing hydrogen of the reformer 10 to generate current. The cell 30 has a pair of substrates 32a and 32b disposed at a side of the reformer 10 to cover the substrate 12 of the reformer 10. The MEA 60 having a catalyst formed thereon is disposed between the substrates 32a and 32b.

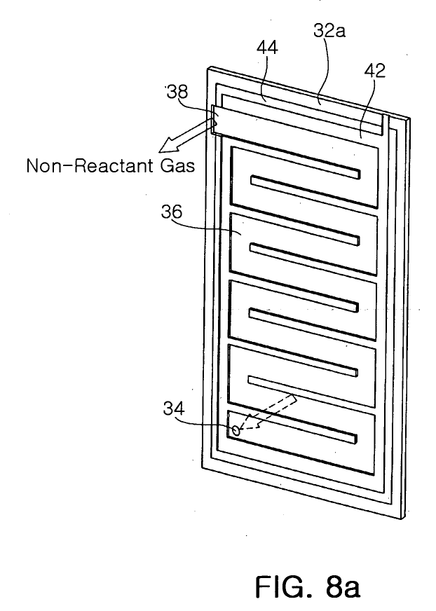

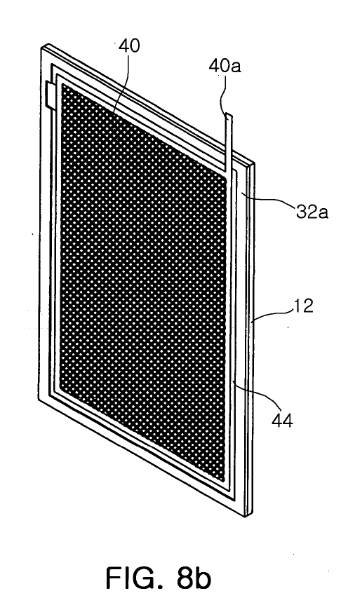

The cell 30 is illustrated in FIGS. 8a to 10. As shown, the cell 30 includes a second substrate 32a disposed adjacent to the substrate 12 of the reformer 10, and a first substrate 32b disposed corresponding to the second substrate 32a. The MEA 60 is disposed between the substrates 32a and 32b.

As shown in FIG. 8a, in the cell 30, the second substrate 32a has a reformed gas inlet 34 formed at a lower side thereof corresponding to and communicating with the reformed gas outlet 18 of the reformer 10. The reformed gas inlet 34 is connected to a recessed flow path 36 formed on the first substrate 32b. The flow path 36 is extended to an upper part of the first substrate 32b, forming a reformed gas passageway. The flow path 36 has a width ranging from about 4 to 4.5 mm and a depth of about 250 μm. In addition, the second substrate 32a also has a non-reactant gas outlet 38 formed at an upper end of the flow path 36. Through the non-reactant gas outlet 38, non-reactant gases, which were not consumed in electric generation at the MEA 60 during the upward movement of the reformed gas in the flow path 36, migrate toward a combustor 80.

In addition, a heating wire (not shown) is formed in the flow path 36 of the second substrate 32a to maintain the reformed gas passing through the flow path 36, i.e., mostly hydrogen gas, at an appropriate temperature. And an insulation coating is formed on the heating wire to insulate the heating wire.

In addition, the second substrate 32a is made of a glass substrate having a thickness of about 500 μm. As shown in FIG. 8b, a second current collector 40 made of a conductive metal, preferably, a copper wire net is attached to the second substrate 32a. The second current collector 40 has a terminal 40a formed at a side thereof to output the collected negative (−) currents to the outside. The second substrate 32a has a seating groove 42 formed in a depth of about 100 μm therein for attaching the second current collector 40 to the second substrate 32a. Thereby, the second current collector 40 is attached to the second substrate 32a by being fixed in the seating groove 42.

In addition, a gasket 62a for mounting the MEA 60, explained later, is disposed at an outer side of the second current collector 40. A groove 44 for fixing the gasket 62a is formed in a depth of about 200 μm in the second substrate 32.

With such seating grooves 42 and 44, the fuel cell system 1 of present invention can be made thinner.

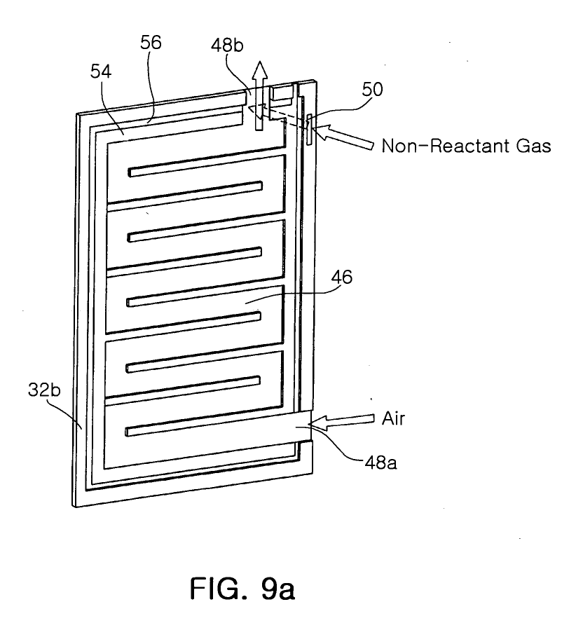

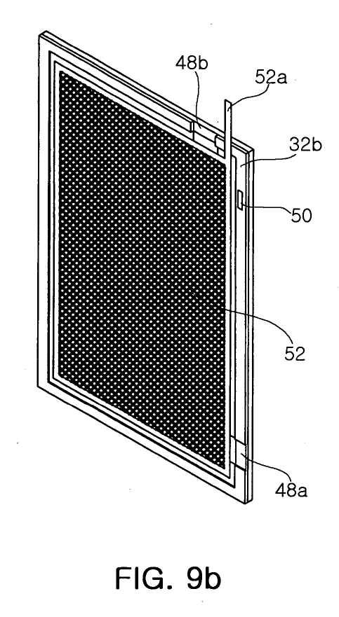

As shown in FIG. 9a, the cell 30 has the first substrate 32b corresponding to the second substrate 32a. The first substrate 32b is made of a silicon wafer having a thickness of about 1 mm, and has an air flow path 46 formed in a side thereof facing the right substrate 32a. The air flow path 46 has a width of about 4 to 4.5 mm and a depth of about 250 μm, and has an air inlet 48a formed at a lower end thereof and an air outlet 48b formed at an upper end thereof.

In addition, the first substrate 32b has a non-reactant gas passage 50 formed thereon communicating with a non-reactant gas outlet 38 of the second substrate 32a when assembled with the second substrate 32a. As shown in FIG. 9b, a first current collector 52 made of a conductive metal, preferably, a copper wire net is attached to the first substrate 32b to cover the airflow path 46. The first current collector 152 has a terminal 52a formed at a side thereof to output the collected positive (+) currents to the outside.

In addition, a seating groove 54 is formed in a depth of about 100 μm in the first substrate 32b to attach the first current collector 52 to the first substrate 32b. The first current collector 52 is fixed in the seating groove 54 of the first substrate 32b. Moreover, a gasket 62b for mounting the MEA 60, explained later, is disposed at an outer side of the first current collector 152. And a groove 56 for fixing the gasket 62b is formed in a depth of about 200 mm in the first substrate 32b.

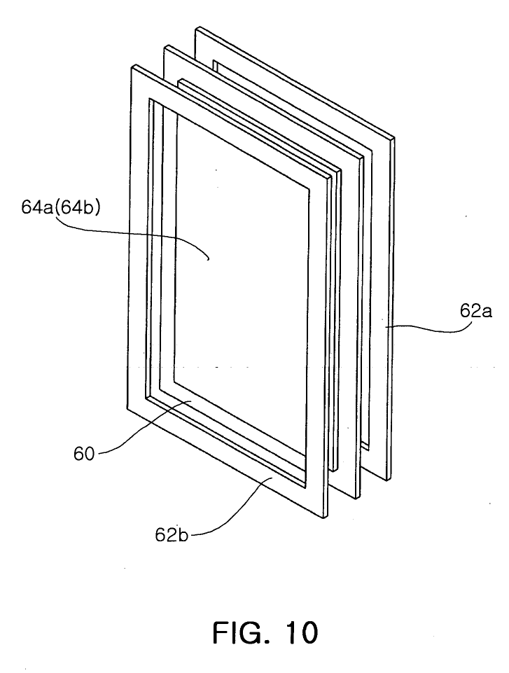

FIG. 10 illustrates the MEA 60 and gaskets 62a and 62b disposed between the second substrate 32a and the first substrate 32b.

The MEA 60 is made suitable for use at a high temperature (120 to 220° C.) since it receives heat from the high-temperature reformer 10. The most representative example of such an MEA 60 is a Polybenzimidazole (PBI) MEA. Using the MEA 60 allows low incidence of capacity degradation and the catalyst to have increased CO tolerance to the toxicity of CO. Thus, a CO remover (not shown) can be advantageously omitted in the reformer 10.

The gaskets 62a and 62b are installed at both sides of the MEA 60 to fix the MEA 60.

The above described MEA 60 has catalysts 64a and 64b made of Pt or Pt/Ru formed on the front and the back side thereof, respectively. The catalysts 64a and 64b promote ionization of hydrogen, and each has increased output density with a larger contact area with hydrogen. In addition, the second current collector 40 and the first current collector 52 attached respectively to the second substrate 32a and the first substrate 32b are in contact with the catalysts 64a and 64b to collect the currents generated from the MEA 60.

In addition, the fuel cell system 1 of the present invention includes a combustor 80 for burning remaining gas to generate heat. The combustor 80 has a substrate 82 disposed at a side of the second substrate 32b of the cell 30. The substrate 82 has a flow path 86 formed therein and a layer of a catalyst 84 formed on the flow path 86.

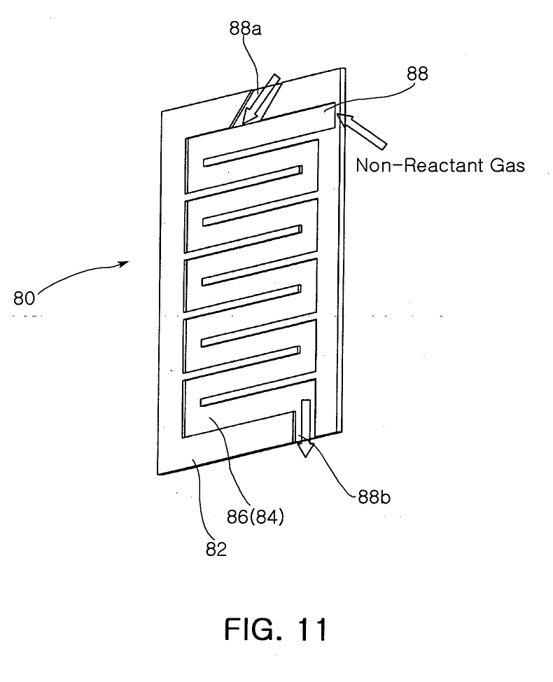

As shown in FIG. 11, the combustor 80 is composed of a glass substrate having a thickness of about 500 μm. The substrate 82 has a non-reactant gas inlet 88 formed therein communicating with the non-reactant gas passage 50 of the first substrate 32b of the cell 30. Thus, non-reactant gases including methanol hydrogen, CO and CO₂ are introduced through the non-reactant gas inlet 88. In addition, the non-reactant gas inlet 88 is formed in the air flow path 86 having a width of about 4 to 4.5 mm and a depth of about 250 μm. The air flow path has an air inlet 88a formed at a side thereof and an air outlet 88b formed at the other side thereof.

Such a combustor 80 has a catalyst 84 of Pt/Al₂O₃ deposited on the inner wall of the flow path 86, so that the non-reactant gases including methanol, hydrogen, CO and CO₂, together with reactant air, generate heat through combustion reaction with the catalyst 84 of Pt/Al₂O₃.

The heat generated in this case varies according to the amount of the non-reactant methanol, gases and air. The heat generated from the combustor 80 uniformly maintains the temperature of the reformer 10 and a thermal insulation layer 90 encapsulating the reformer 10. Such a combustor 80 can be removed to simplify the system if the heating wire of the reformer 10 supplying the heat necessary is highly efficient.

The present invention may also include the insulation layer 90 encapsulating the reformer 10, the cell 30 and the combustor 80. The insulation layer 90 serves to block the internally generated heat from the external environment to minimize heat losses. A large thickness of the insulation layer 90 results in the enlarged system, and thus the material and sealing method of insulation should be selected to maximize the insulation efficiency. Preferably, vacuum thermal insulation yields superior effects.

Thus, in the multi-layered thin film hydrogen fuel cell system 1 with the above described configuration according to the first embodiment of the invention, when methanol (CH₃OH) and water (H₂O) of hydrocarbon compound fuel is supplied through the fuel inlet 16 of the reformer 10 and heated at a reaction temperature ranging from 150° C. to 250° C., a reformation process accompanying heat absorption reaction takes place and thereby hydrogen gas and the small amount of, preferably, less than 2% of CO, water and CO₂ is emitted from the reformed gas outlet 18.

While the reformed gas migrates upward through the reformed gas inlet 34 of the second substrate 32a of the cell 30, it contacts the catalyst layer 64a of the MEA. During this process, hydrogen gas is disintegrated into hydrogen ions (H⁺) and electrons (e⁻), of which only the hydrogen ions pass through the MEA 60, and the electrons (e⁻) migrate through the second current collector 40. Due to the flow of the electrons (e⁻) at this time, current is generated.

At the other catalyst 64b of the MEA 60, the hydrogen ions (H⁺) react with the air introduced through the air inlet 48a to produce and emit vapor through the air outlet 48b. The current generated in this process is collected by the first and second current collectors 40 and 52.

On the other hand, at the second substrate 32a, the non-reactant gases, which were not consumed in the electric generation at the MEA during the upward movement of the reformed gas, migrate upward to the non-reactant gas outlet 38 and enters the combustor 80 through the non-reactant gas passage 50.

In the combustor 80, non-reactant gases including methanol, hydrogen, CO and CO₂ introduced into the air flow path, together with the reactant air, generate heat through combustion reaction with the catalyst of Pt/Al₂O₃.

The heat generated in this case uniformly maintains the temperature of the reformer 10 and the thermal insulation layer 90 encapsulating the reformer 10.

In the present invention, the reformer 10, the cell 30 and the combustor 80 are made of a silicon substrate or a glass layer alternately to facilitate bonding between the layers.

For example, the substrate 82 of the combustor 80 is made of a glass layer, the first substrate 32b of the cell 30 is made of a silicon wafer, the second substrate 32a of the cell 30 is made of a glass layer and the substrate 12 of the reformer 10 is made of a silicon wafer. The substrates are bonded via anodic bonding or eutectic bonding. In particular, when there is a need to lower the bonding temperature, eutectic bonding is used, in which case, the layers bonded should all be made of silicon wafers.

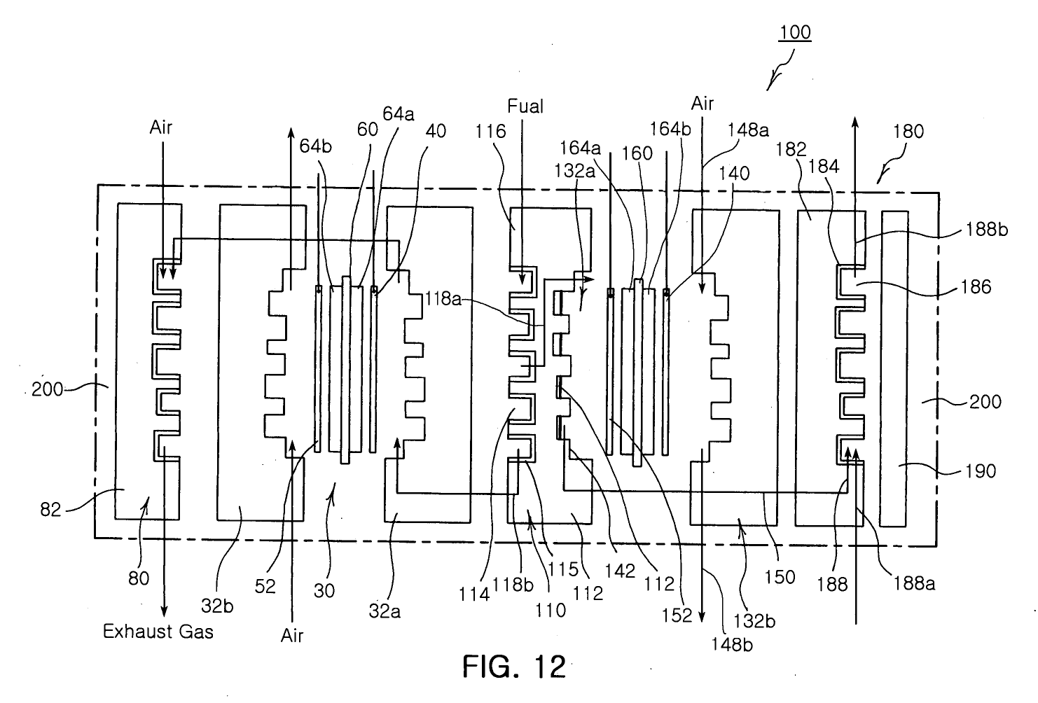

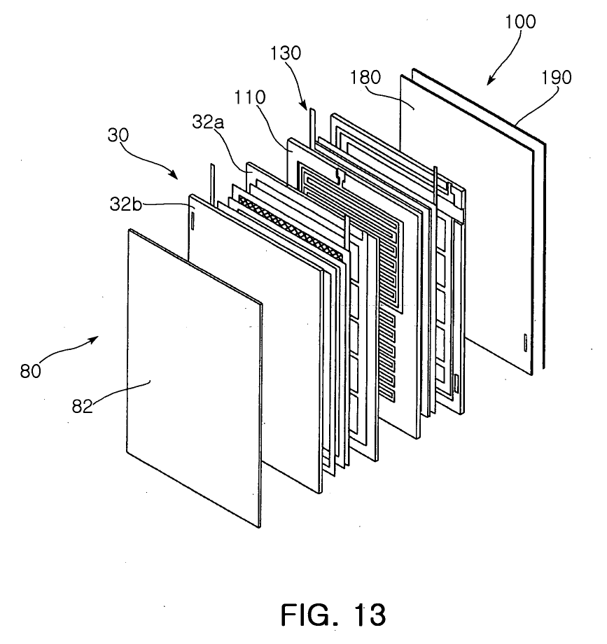

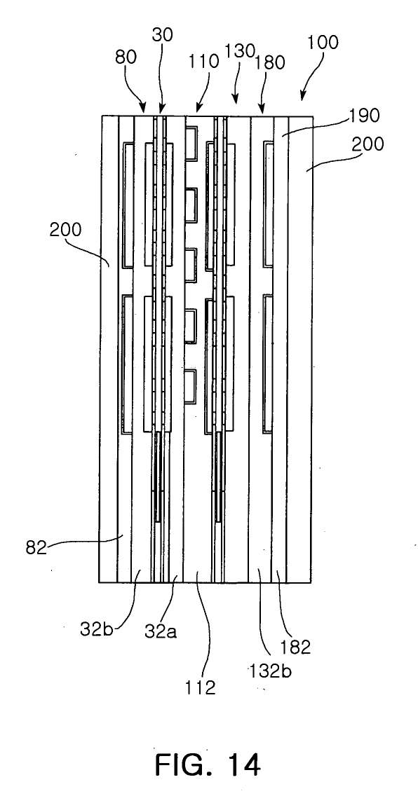

FIGS. 12 to 14 illustrate a multi-layered thin film hydrogen fuel cell system according to a second embodiment of the invention.

The multi-layered thin film hydrogen fuel cell 100 according to the second embodiment of the invention includes a reformer having a substrate 112 with a flow path formed on a side thereof and a catalyst formed in the flow path, thereby reforming fuel into hydrogen.

The reformer 110 is a part for generating hydrogen from fuel, and generally adopts a catalyst 115 of CuO/ZnO/Al₂O₃ or Cu/ZnO/Al₂O₃ in the case of methanol steam reformation. The reforming reaction temperature is selected in a range of 150° C. to 250° C. considering the hydrogen conversion rate and CO generation density of 2% or less so that and an MEA is not affected.

The substrate 112 of the reformer 110 is made of Si. It has a structure similar to that shown in FIG. 7, having a recessed flow path 114 formed in zigzag in a side thereof. The recessed flow path 114 has a fuel inlet 116 formed in an upper part thereof, a first reformed gas outlet 118a formed in a middle part thereof, and a second reformed gas outlet 118b formed in a lower part thereof.

The first reformed gas outlet 118a is for supplying reformed gas to a second cell 130, explained later, and the second reformed gas outlet 118b is for supplying the reformed gas to a first cell 30.

Except for the plurality of first and second reformed gas outlets 118a and 118b, the reformer 110 is identical to the one explained in the first embodiment, and thus a detailed explanation thereof is omitted.

In the second embodiment of the present invention, substrates covering the substrate 112 of the reformer are disposed at both sides of the substrate 112 of the reformer. Disposed between each pair of the substrates is a pair of cells 30 and 130 having an MEA 60 and 160. The MEAs 60 and 160 have catalysts 64a and 64b, 164a and 164b formed thereon. The cells 30 and 130 generate current using the hydrogen from the reformer 110.

The first cell 30 shown in FIG. 12 is identical to the cell in the first embodiment, and thus a detailed explanation thereof is omitted. The same reference numerals are used to designate the same constituents.

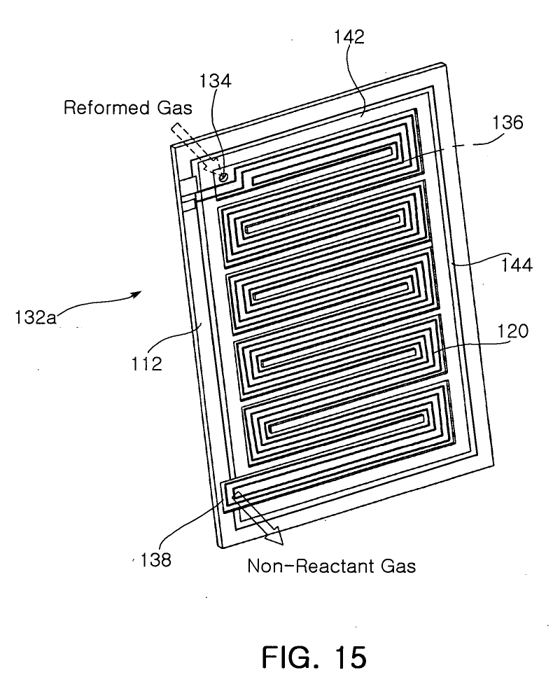

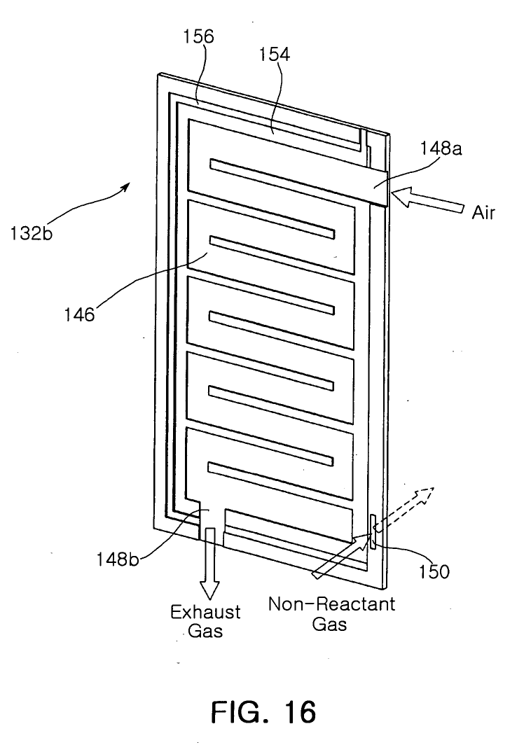

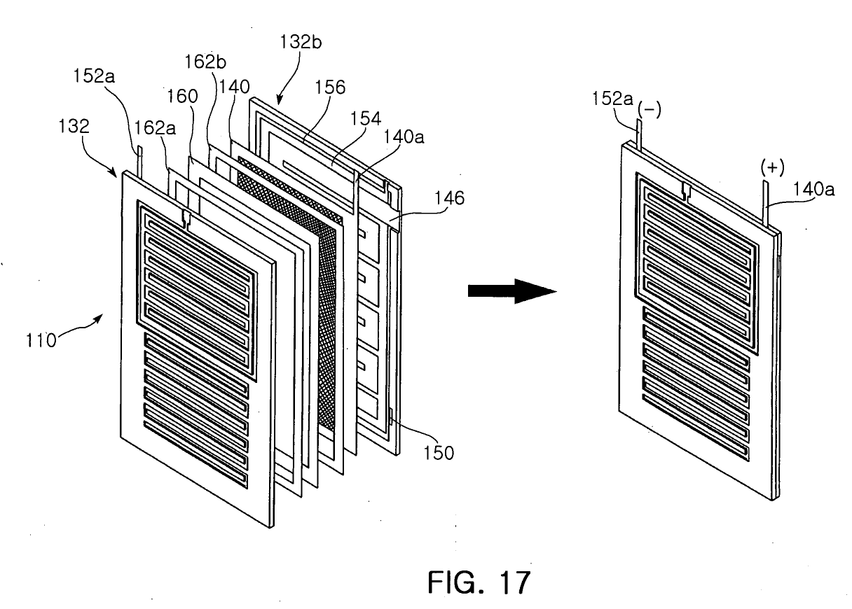

The second cell 130 formed at the right side of the reformer 110 has a first substrate 132a shown in FIG. 15 and a second substrate 132b shown in FIG. 16, with the MEA 160 disposed therebetween as shown in FIG. 17.

As shown in FIG. 15, the first substrate 132a formed on the rear side of the reformer includes a reformed gas inlet 134 formed at an upper part thereof communicating with the first reformed gas outlet 118a of the reformer 110. The reformed gas inlet 134 is connected to a recessed flow path 136 formed on the first substrate 132a. The flow path 136 extends to a lower part of the first substrate 132a, forming a gas passageway, and has a width of about 4 to 4.5 mm and a depth of about 250 μm. In addition, the first substrate 132a has a non-reactant gas outlet 138 formed at a lower side of the flow path 136. Through the non-reactant gas outlet 138, non-reactant gases, which were not consumed during the electric generation at the MEA 160 during the upward movement of the reformed gas, enters a combustor 180, explained later.

In addition, a heating wire 120 of Pt/Ti is formed in the flow path 136 of the first substrate 132a to maintain the reformed gas passing through the f low path 136 at an appropriate temperature, and an insulation coating is formed on the heating wire 120 to insulate the heating wire 120.

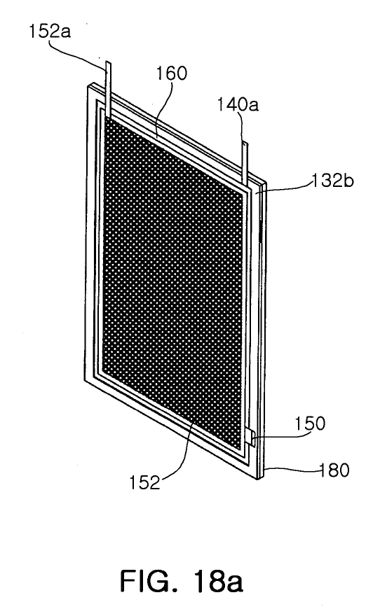

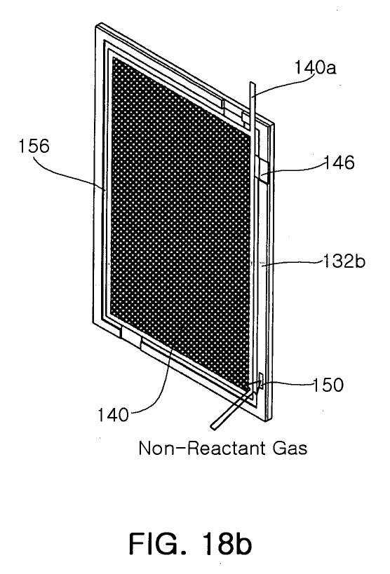

In addition, as shown in FIG. 18a, a first current collector 152 made of a conductive metal, preferably, a copper wire net is attached to the first substrate 132a to cover the flow path 136. The first current collector 152 has a terminal 152a formed at a side thereof to output the collected negative (−) currents to the outside. The first substrate 132a has a seating groove 142 having a depth of about 100 μm formed therein for attaching the first current collector 152 to the first substrate 132a. Thereby, the first current collector 152 is attached to the first substrate 132a by being fixed in the seating groove 142. In addition, a gasket 162a for mounting the MEA, explained later, is disposed at an outer side of the first current collector 152. The first substrate 132a has a groove 144, for fixing the gasket 162a, formed in a depth of about 200 μm therein.

With such seating groove 142 and groove 144, the fuel cell system 100 of the present invention can be made thinner.

The second cell 130 has a second substrate 132b shown in FIG. 16, corresponding to the first substrate 132a. The second substrate 132b is made of a glass having a thickness of about 1 mm, and has an air flow path 146 formed in the side facing the first substrate 132a. The air flow path 146 has a width of about 4 to 4.5 mm and a depth of about 250 μm, having an air inlet 148a formed at an upper end thereof and an air outlet 148b formed at a lower end thereof.

In addition, the second substrate 132b has a non-reactant gas passage 150 formed at a lower end thereof corresponding to and communicating with the non-reactant gas outlet 138 of the first substrate 132a when assembled with the first substrate 132a. As shown in FIG. 18b, a second current collector 140 made of a conductive metal, preferably, a copper wire net is attached to the second substrate 132b to cover the air flow path 146. The second current collector 140 has a terminal 140a formed at a side thereof to output the collected positive (+) currents to the outside.

In addition, the second substrate 132b has a seating groove 154 formed in a depth of about 100 μm therein to attach the second current collector 140 to the second substrate 132b. Thereby, the second current collector 140 is attached to the second substrate 132b by being fixed in the seating groove 154. In addition, a gasket 162b for mounting the MEA 160, explained later, is disposed at an outer side of the second current collector 140. The second substrate 132b also has a groove 156, for fixing the gasket 162b, formed in a depth of about 200 μm.

FIG. 17 illustrates the MEA 160 and the gaskets 162a and 162b disposed between the first substrate 132a and the second substrate 132b.

The MEA 160 is made suitable for use at a high temperature ranging from 120 to 220° C. since it receives heat from the reformer 110 operating at high temperature. The most representative example of such an MEA 160 is a Polybenzimidazole (PBI) MEA similar to the first embodiment. Using such an MEA 160 allows low incidence of capacity degradation during the operation at high temperature and the catalyst to have increased CO tolerance to the toxicity of CO. Thereby, the CO remover (not shown) can be advantageously omitted in the reformer 110.

To fix the MEA 160, the gaskets 162a and 162b are installed at both sides of the MEA 160.

The MEA 160 has catalysts of Pt or Pt/Ru formed thereon. The catalysts 164a and 164b promote ionization of hydrogen and each has increased output density with an increased area in contact with hydrogen.

The first current connector 152 and the second current collector 140 attached respectively to the left substrate 132a and the right substrate 132b are in contact with the catalysts 164a and 164b to collect the currents generated from the MEA 160.

That is, the reformed gas which is mostly hydrogen, is introduced into an upper left part of the first substrate 132a to migrate along the flow path 136 to exit a lower left part thereof. During this migration, hydrogen H2 reacts with the anode catalyst 164a of the MEA 160 and separated electrons exit through the first current collector 152 to flow through external wires. At this time, the hydrogen ions H+ which lost the electrons are ion-transferred through the MEA 160. The reformed gas exiting through the end of the flow path 136 includes non-reactant hydrogen and carbon monoxide, carbon dioxide gases produced during the reforming reaction. The non-reactant gases enter the right combustor 180 for catalytic combustion reaction.

A heating wire 120 which is formed in the flow path 136 has its surface insulated, thus not reacting with the first current collector 152 and the hydrogen gas.

In addition, the fuel cell system 100 of the present invention includes a second combustor 180 for burning remaining gas to generate heat. The second combustor 180 has a substrate 182 disposed at a side of the second substrate 132b of the second sell 130. The substrate 182 has a flow path 186 with a catalyst 184 formed thereon.

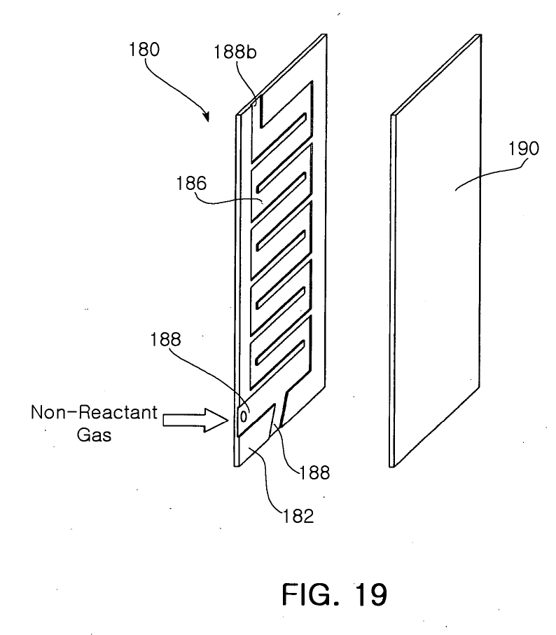

As shown in FIG. 19, the second combustor 180 is composed of a silicon substrate 182 having a thickness of about 500 μm. The substrate 182 has a non-reactant gas inlet 188 formed thereon corresponding to and communicating with the non-reactant gas passage 150 formed on the second substrate 132b of the second cell. Through the non-reactant gas inlet 188, non-reactant gases including methanol, hydrogen, CO and CO₂ enter the combustor 180. The non-reactant gas inlet 188 is formed at an end of the air flow path 186 having a width of about 4 to 4.5 mm and a depth of about 250 μm. The air flow path 186 has an air inlet 188a formed at a side or a lower end thereof and an air outlet 188b formed at an upper part thereof.

Such a combustor 180 has a catalyst 184 of for example Pt/Al₂O₃ deposited on the inner wall of the flow path 186, so that non-reactant gases including methanol, hydrogen, CO and CO₂ introduced into the flow path 186, together with the reactant air, generate heat through combustion reaction with the catalyst 184 of Pt/Al₂O₃.

As shown in FIG. 19, such a second combustor 180 includes a glass cover 190 bonded thereto in order to seal the flow path 186 thereof.

Such a glass cover 190 has a depth of about 250 μm and is attached to seal the flow path 186 of the substrate 182.

In the second embodiment of the present invention, the reformer 110, the first and second cells 30 and 130, and the first and second combustors 80 and 180 are made of a silicon substrate or a glass layer alternately to facilitate bonding between the substrates.

For example, in the second embodiment of the invention, the substrate 82 of the first combustor 80 is made of a glass layer, the first substrate 32b of the first cell 30 is made of a silicon wafer, the second substrate 32a of the first cell 30 is made of a glass layer and the substrate 112 of the reformer 110 is made of a silicon wafer. In addition, the second substrate 132b of the second cell 130 is made of glass, and the second combustor 180 is made of silicon substrate with a glass cover 190 for covering the same.

The substrates can be bonded to each other via anodic bonding or eutectic bonding. Especially when there is a need for lowering the bonding temperature, eutectic bonding is used, in which the layers bonded should all be made of silicon wafers.

In addition, there may be an insulation layer for encapsulating the reformer 110, the cell 130 and the combustor 180. The insulation layer 200 serves to block the heat generated internally from the external environment to minimize heat losses. A large thickness of the insulation layer 200 results in the enlarged system, and thus material and sealing method of insulation should be adopted to maximize the insulation efficiency. Preferably, vacuum thermal insulation can yield the greatest effects.

In the meantime, the heat generated from the combustor 180 can vary according to the amount of non-reactant methanol, gasses and air. The heat uniformly maintains the temperature of the reformer 110 and the thermal insulation layer 200 encapsulating the reformer 110. Such a combustor 180 can be removed to simplify the system if the heating wire of the reformer 110 supplying heat necessary for reformation is highly efficient.

In the multi-layered thin film hydrogen fuel cell system 100 with the above configuration according to the second embodiment of the present invention, methanol (CH₃OH) and water (H₂O) of hydrocarbon fuel is supplied into the fuel inlet 116 of the reformer 110 and heated at a reaction temperature ranging from 150° C. to 250° C. Then, a reformative process accompanying heat absorption reaction takes place and hydrogen gas and the small amount of, preferably, less than 2% of CO, wafer and CO₂ is emitted through the first and second reformed gas outlets 118a and 118b.

The reformed gas migrates to the second cell 130 through the first reformed gas outlet 118a and migrates to the first cell 30 through the second reformed gas outlet 118b. The reformed gas entering the first cell 30 is reformed through the same process explained in the first embodiment to generate current, and thus the detailed explanation thereof is omitted.

The reformed gas bound for the second cell 130 through the first reformed gas outlet 118a enters the reformed gas inlet 134 provided in the first substrate 132a of the second cell 130 and migrates downward to contact the anode catalyst 164a of the MEA 160. During this process, the hydrogen gas is disintegrated into hydrogen ions (H⁺) and electrons (e⁻), of which only the hydrogen ions pass through the MEA 160, and at the same time, the electrons (e⁻) migrate through the first current collector 152. Due to the flow of the electron (e⁻) at this time, current is generated.

In addition, as shown in FIG. 16, at the cathode catalyst 164b at the other side of the second MEA 160, the hydrogen ions (H⁺) react with the air introduced through the air inlet 148a to generate and emit vapors through the air outlet 148b. The current generated during this process is collected by the first and second current collectors 140 and 152.

In the meantime, in the first substrate 132a of the second cell 130, the non-reactant gases that were not consumed during the electric generation during the downward movement of the reformed gas, migrate downward to the non-reactant gas outlet 138 and are transferred through the non-reactant gas passage 150 of the second substrate 132b to a lower part of the second combustor 180.

Then, in the second combustor 180, non-reactant gases including methanol, hydrogen, CO and CO₂ introduced into the flow path 186 thereof migrate upward along the flow path 186 to generate heat, together with the reactant air, through combustion reaction with the catalyst 184 of Pt/Al₂O₃. The heat generated at this time uniformly maintains the temperature of the reformer 110 and the thermal insulation layer 200 encapsulating the reformer 110.

The multi-layered thin film hydrogen fuel cell system 100 according to the second embodiment of the invention supplies hydrogen gas to the first and second cell 30 and 130 through the reformer 110, generating current at the first and second cell 30 and 130, thereby providing the temperature necessary for generating current in the combustors 80 and 180 via the MEAs 60 and 160.

Therefore, the multi-layered thin film hydrogen fuel cell system 100 according to the second embodiment of the invention has a miniaturized structure and maintains high capacity with high current generation efficiency.

According to the present invention set forth above, substrates of a reformer, a cell and a combustor are easily manufactured using MEMS technology and can thus be mass produced.

In addition, the reformer and the cell are integrally connected and uses hydrocarbon compound fuel, allowing high output with high current density and quick response characteristics. Moreover, the fuel maintained stably at the normal temperature allows safe operation. Therefore, due to such improvements, the present invention is applicable to a power supplying apparatus or a portable power generator like a battery for a portable electronic device such as a mobile phone, a personal digital assistant, a camcorder, a digital camera, a notebook computer and the like.

While the present invention has been shown and described in connection with the preferred embodiments, it will be apparent to those skilled in the art that modifications and variations can be made without departing from the spirit and scope of the invention as defined by the appended claims.

What is claimed is:

1. A multi-layered thin film hydrogen fuel cell system using hydrogen carbon compound as fuel, comprising:
a reformer comprising a flow path formed at a side of a substrate and a catalyst in the flow path to reform a fuel into hydrogen;
a cell for generating current using the hydrogen from the reformer, the cell comprising a pair of first and second substrates covering the substrate of the reformer, the first substrate disposed at the side of the reformer, and a membrane electrode assembly disposed between the pair of substrates with a catalyst formed thereon; and
a combustor for burning remaining fuel gas to generate heat, the combustor comprising a substrate disposed at an outer side of the second substrate of the cell, and a flow path formed in the substrate with a catalyst formed thereon.

2. The multi-layered thin film hydrogen fuel cell system according to claim 1, wherein the catalyst is made of CuO/ZnO/Al₂O₃ or Cu/ZnO/Al₂O₃ deposited on the inner wall of the flow path thereof, and the reformer comprises a heater on the rear side of the substrate thereof.

3. The multi-layered thin film hydrogen fuel cell system according to claim 1, wherein the cell has a heating wire formed in the flow path of the second substrate to maintain reformed gas passing through the flow path at an appropriate temperature, and has an insulation coating formed on the heating wire to insulate the heating wire.

4. The multi-layered hydrogen thin film fuel cell system according to claim 2, wherein the cell has a non-reactant gas outlet formed on the second substrate and a non-reactant gas passage formed on the first substrate corresponding to and communicating with the non-reactant gas outlet to transfer non-reactant reformed gas toward the combustor.

5. The multi-layered thin film hydrogen fuel cell system according to claim 4, wherein the second substrate of the cell has a flow path forming a reformed gas passage, and a recess for mounting a current collector.

6. The multi-layered thin film hydrogen fuel cell system according to claim 5, wherein the second substrate has a groove for fixing a gasket for attaching the membrane electrode assembly.

7. The multi-layered thin film hydrogen fuel cell system according to claim 4, wherein the first substrate has a flow path forming an air passage, and a recess for mounting a current collector.

8. The multi-layered thin film hydrogen fuel cell system according to claim 4, wherein the first substrate has a groove for fixing a gasket for attaching the membrane electrode assembly.

9. The multi-layered thin film hydrogen fuel cell system according to claim 1, wherein the membrane electrode assembly comprises a Polybenzimidazole (PBI) membrane electrode assembly, and the cell has gaskets installed at both sides of the membrane electrode assembly for attaching the same.

10. The multi-layered thin film hydrogen fuel cell system according to claim 1, wherein the combustor has a non-reactant gas passage on the first substrate of the cell and a non-reactant gas inlet corresponding to and communicating with the non-reactant gas inlet formed in an air flow path of the combustor, whereby non-reactant gas introduced into the air flow path generates heat through combustion reaction with a catalyst formed in the air flow path.

11. A multi-layered thin film hydrogen fuel cell system using hydrocarbon compound as fuel, comprising:
a reformer comprising a flow path formed at a side of a substrate and a catalyst formed in the flow path to reform a fuel into hydrogen;
first and second cells disposed at both sides of the reformer for utilizing hydrogen from the reformer to generate current, each of the cells comprising a substrate to cover the substrate of the reformer and a membrane electrode assembly disposed in the substrate of the cell with a catalyst thereon; and
first and second combustors for burning remaining fuel gas, the first combustor disposed at an outer side of the substrate of the first cell, the second combustor disposed at an outer side of the substrate of the second cell, each of the combustors comprising a substrate having a flow path formed in the substrate of the combustor with a catalyst formed thereon.

12. The multi-layered thin film hydrogen fuel cell system according to claim 11, wherein the substrate of the reformer has a recessed flow path formed on a side thereof, the flow path having a fuel inlet, a first reformed gas outlet and a second reformed gas outlet.

13. The multi-layered thin film hydrogen fuel cell system according to claim 11, the substrate of the second cell comprises a first substrate part formed on the rear side of the substrate of the reformer, the first substrate part having a flow path recessed therein.

14. The multi-layered thin film hydrogen fuel cell system according to claim 13, the second cell has a heating wire formed in the flow path thereof to maintain the reformed gas passing through the flow path at an appropriate temperature and an insulation coating formed on the heating wire to insulate the heating wire.

15. The multi-layered thin film hydrogen fuel cell system according to claim 13, wherein the second cell has a seating groove formed for seating a current collector.

16. The multi-layered thin film hydrogen fuel cell system according to claim 13, wherein the substrate of the second cell has a groove for fixing a gasket for attaching the membrane electrode assembly.

17. The multi-layered thin film hydrogen fuel cell system according to claim 13, wherein the substrate of the second cell comprises a second substrate part opposed to the first substrate part, wherein the second substrate part has a flow path forming an air passage and a seating groove for seating a current collector.

18. The multi-layered thin film hydrogen fuel cell system according to claim 13, wherein the substrate of the second cell comprises a second substrate part opposed to the first substrate part, wherein the second substrate part has a groove for fixing a gasket for attaching a membrane electrode assembly.

19. The multi-layered thin film hydrogen fuel cell system according to claim 11, wherein one of the combustors includes a glass cover assembled thereto to seal the flow path therein.
